(19) United States
(12) Patent Application Publication
(10) Pub. No.: US 2026/0365228 A1
(43) Pub. Date: Nov. 19, 2026

(54) DRIVE AND STEERING DEVICE FOR A VEHICLE AND VEHICLE COMPRISING AT LEAST ONE DRIVE AND STEERING DEVICE OF THIS TYPE

(71) Applicant: Schaeffler Technologies AG & Co. KG, Herzogenaurach (DE)

(72) Inventors: Chi Cuong Hoang, Singapore (SG); Keane Zhe Wei Hi, Singapore (SG)

(73) Assignee: Schaeffler Technologies AG & Co. KG, Herzogenaurach (DE)

(21) Appl. No.: 19/154,390

(22) PCT Filed: Jan. 17, 2024
(86) PCT No.: PCT/DE2024/100037

§ 371 Date: Aug. 7, 2025

(30) Foreign Application Priority Data
Feb. 7, 2023 (DE) 10 2023 102 873.1

(51) Int. Cl. B62D 5/04; B60K 7/00; B60K 17/14

(52) U.S. Cl. CPC B62D 5/0418; B60K 7/0007; B60K 17/14; B62D 5/0403; B62D 5/046

(57) ABSTRACT

A vehicle drive-and-steering device, includes—two hollow shaft motors, each having a bevel ring gear fixed to a shaft motor rotor. The bevel ring gears are arranged coaxially. Bevel pinions are rotationally fixed together via a shaft arranged in between. The bevel pinions are meshed with both bevel ring gears. A vehicle wheel is fixed on a wheel hub which is arranged on a supporting arm The supporting arm is arranged on the shaft and supported on the second shaft motor via a bearing point on the second shaft motor inner circumference. A force-transmission device is arranged between the shaft and the wheel hub for driving same. The bevel ring gears are driven by the associated shaft motors. In a relative rotational direction and speed of the bevel ring gears, there is wheel hub driving and/or wheel hub pivoting about a drive-and-steering device longitudinal axis to adjust the wheel steering angle.

The invention relates to a drive and steering device for a vehicle and to a vehicle having at least one drive and steering device of this type.

So-called AMRs (autonomous mobile robots) with all-wheel drive and all-wheel steering usually have four drive modules at each corner of the AMR, wherein each drive module has two independent motors, one for steering the respective wheel and the other for driving the respective wheel.

DE 691 09 453 T2 discloses a drive and steering device which is operatively mounted between a frame and a steering and drive wheel in order to drive the wheel about the wheel axis and to steer the wheel about a steering axis relative to the frame. The device comprises a steering motor which has a stator that is connected to the frame and a rotor, wherein the rotor is operatively connected to the wheel in order to steer the wheel about the steering axis. In addition, driving means are provided which include a traction motor which is operatively connected to the wheel in order to drive it about the wheel axis. The driving means extend through the stator and are connected to the rotor of the steering motor for drive purposes.

The object of the present invention is to propose a drive and steering device which is space-saving, requires comparatively few components and is easy to assemble. This object is achieved by a drive and steering device having the features of claim 1 and by a vehicle having the features of claim 9. Preferred or advantageous embodiments of the invention arise from the dependent claims, the following description and the appended figures.

A drive and steering device for a vehicle according to a first aspect of the invention comprises
a first hollow shaft motor, having a first bevel ring gear that is at least indirectly rotationally fixed to a first rotor of the first hollow shaft motor,
a second hollow shaft motor, having a second bevel ring gear that is at least indirectly rotationally fixed to a second rotor of the second hollow shaft motor, wherein the two bevel ring gears are arranged coaxially to one another,
a first bevel pinion and a second bevel pinion, wherein the bevel pinions are rotationally fixed to one another via a shaft arranged in between, and wherein each of the bevel pinions is meshed with both the first bevel ring gear and the second bevel ring gear,
a wheel of the vehicle that is arranged on a wheel hub in a rotationally fixed manner,
at least one supporting arm on which the wheel hub is rotatably arranged, wherein the at least one supporting arm is arranged on the shaft via at least one rotary joint and is radially supported on the second hollow shaft motor via a bearing point arranged on an inner circumference of the second hollow shaft motor,
a mechanical force-transmission device that is drivingly arranged between the shaft and the wheel hub for rotationally driving the wheel hub about its longitudinal axis,

wherein the bevel ring gears can be rotationally driven by the associated hollow shaft motors in such a way that, according to a relative rotational direction and relative rotational speed of the bevel ring gears to one another, there is a rotational driving of the wheel hub about its longitudinal axis and/or a pivoting of the wheel hub about a longitudinal axis of the drive and steering device in order to adjust a steering angle of the wheel.

The drive and steering device proposed here is characterized by a compact, coaxial design that is easy to assemble. The coaxial arrangement of the motors also allows for high ground clearance. In addition, the drive and steering device requires few components, which means that the drive and steering device can be designed to be particularly simple and lightweight compared to previously known solutions. Furthermore, a continuous 360-degree steering module can be implemented, which allows the wheel to be pivoted by at least 360°, making the drive and steering device particularly suitable for use on an AMR.

Since the bevel ring gears are arranged coaxially to one another, the hollow shaft motors are also arranged coaxially to one another. Consequently, the stators and rotors of the two hollow shaft motors are arranged coaxially to one another within a motor housing. The respective hollow shaft motor comprises a stator secured to the housing and a rotor arranged to rotate relative thereto, which is designed as a hollow shaft rotor having a hollow space. Each rotor is preferably directly rotationally fixed to the associated bevel ring gear. However, other components can also be arranged between the rotor and the associated bevel ring gear, such as spacers or the like.

The hollow shaft motors are configured to communicate with a control device which can control the respective hollow shaft motor in such a way that the rotor with the bevel ring gear that is at least indirectly rotationally fixed thereto rotates in a desired rotational direction at a variably adjustable rotational speed. The hollow shaft motors are therefore in communication with at least one control device.

The two bevel ring gears are designed as rings with end-face toothing or spur toothing, wherein the toothings are arranged facing each other and spatially accommodate the two bevel pinions between them.

Each bevel pinion has a toothing complementary to the toothing of the bevel ring gears. Depending on the rotational direction of the rotors or the bevel ring gears, the bevel pinions can be driven by the hollow shaft motors or the bevel ring gears in such a way that they rotate together at the same speed about the longitudinal axis of the shaft. The shaft is a connecting element for the two bevel pinions. Depending on the selection of the rotational direction and rotational speed of the rotors or the bevel ring gears, a rotational driving of the wheel or a pivoting of the wheel to adjust a steering angle is realized either via the shaft and the mechanical force-transmission device or via the shaft and at least one supporting arm.

The articulated arrangement of the at least one supporting arm on the shaft by means of the swivel joint ensures that the at least one supporting arm cannot rotate about the longitudinal axis of the shaft. The shaft is therefore rotatably mounted to at least one supporting arm.

In addition, the bearing point between the at least one supporting arm and the second hollow shaft motor is provided to prevent rotation of the at least one supporting arm about the longitudinal axis of the drive and steering device. Thus, at least the second rotor of the second hollow shaft motor is rotatably mounted relative to at least one supporting arm. The at least one supporting arm is supported at least axially on the shaft and at least radially on the bearing point. The bearing point is preferably designed as a bearing bush or as a bearing element.

At least one supporting arm is part of a fork device that indirectly supports the wheel on the hollow shaft motors. The fork device may comprise one supporting arm, two supporting arms or more than two supporting arms on which the wheel is rotatably accommodated. Preferably, the wheel hub is rotatably arranged on two supporting arms, wherein the wheel is arranged in the longitudinal direction of the wheel hub between the two supporting arms. This allows for better force introduction and transmission.

The wheel hub is rotationally fixed to the wheel. The wheel hub and the wheel can be formed as one piece. However, a two-part design can be advantageous because different materials can be used if the wheel hub is subjected to higher or different stresses than the wheel.

Preferably, the mechanical force-transmission device is a traction drive or a gear transmission. In particular, the force-transmission device is a belt drive, comprising a first belt pulley arranged in a rotationally fixed manner on the shaft and a second belt pulley arranged in a rotationally fixed manner on the wheel hub, wherein the belt pulleys are drivingly connected via a traction means, in particular a toothed belt. A force-transmission device designed as a gear transmission has at least two gears that mesh with one another, a first gear being arranged in a rotationally fixed manner on the shaft and a second gear being arranged in a rotationally fixed manner on the wheel hub. Further gears are also conceivable, which are arranged between the first and second gear on a respective intermediate shaft.

Preferably, a first stator of the first hollow shaft motor is configured to be fastened to a chassis of the vehicle via a first chassis mounting plate. Alternatively or additionally, a second stator of the second hollow shaft motor is configured to be secured to the chassis of the vehicle via a second chassis mounting plate. By appropriately arranging the hollow shaft motors on the chassis, the ground clearance can be further increased. The chassis mounting plates can be part of the chassis or part of the drive and steering device. Depending on the vehicle design, the chassis mounting plates can be connected in one piece to the corresponding stator.

Preferably, the drive and steering device comprises a control device which is configured to control the hollow shaft motors in such a way that the bevel ring gears are rotated at the same rotational speed in opposite rotational directions, whereby the wheel hub rotates about its longitudinal axis in a first rotational direction or in a second rotational direction opposite thereto. In a method for controlling a drive and steering device according to a further aspect of the invention, when the bevel ring gears are rotated by the hollow shaft motors at the same rotational speed in opposite rotational directions, the wheel hub rotates about its longitudinal axis in a first rotational direction or in a second rotational direction opposite thereto.

Alternatively or additionally, the control device is designed to control the hollow shaft motors such that the bevel ring gears are rotated at the same rotational speed in the same rotational direction, whereby the wheel hub pivots about the longitudinal axis of the drive and steering device in a third rotational direction or in a fourth rotational direction opposite thereto. In a method for controlling a drive and steering device according to a further aspect of the invention, when the bevel ring gears ( ) are rotated by the hollow shaft motors at the same rotational speed in the same rotational direction, the wheel hub pivots about the longitudinal axis of the drive and steering device in a third rotational direction or in a fourth rotational direction opposite thereto.

Furthermore, alternatively or additionally, the control device is configured to control the hollow shaft motors such that the bevel ring gears are rotated by the hollow shaft motors at different rotational speeds in opposite rotational directions, whereby the wheel hub rotates about its longitudinal axis in the first rotational direction or in the second rotational direction and pivots about the longitudinal axis of the drive and steering device in the third rotational direction or the fourth rotational direction. In a method for controlling a drive and steering device according to a further aspect of the invention, when the bevel ring gears are rotated in opposite rotational directions by the hollow shaft motors at different rotational speeds, the wheel hub rotates about its longitudinal axis in the first rotational direction or in the second rotational direction and accordingly pivots about the longitudinal axis of the drive and steering device in the third rotational direction or the fourth rotational direction when the bevel ring gears are rotated in opposite rotational directions by the hollow shaft motors at different rotational speeds.

The steering of the wheel is based on the difference between the rotational or turning speeds of the bevel ring gears. The driving of the wheel depends linearly on the rotational speeds of the rotors or bevel ring gears.

An active connection or a drive connection is understood to be either a direct or at least indirect connection between two elements. Therefore, the two interconnected elements can be connected either directly or via other elements. Thus, as already explained above, several gears or belt pulleys and, if necessary, traction means or the like can be arranged between the shaft and the wheel hub for rotationally driving the wheel hub about its longitudinal axis in order to transmit drive power, i.e. torque and rotational speed, from the shaft to the wheel hub or vice versa.

A vehicle according to a second aspect of the invention comprises at least one drive and steering device according to the first aspect of the invention, wherein the at least one drive and steering device is arranged and supported on a chassis of the vehicle. Preferably, multiple drive and steering devices according to the first aspect of the invention are connected to the chassis in order to provide a vehicle that can be used for different applications. The vehicle can in particular be designed as a so-called AMR (Autonomous Mobile Robot), on which products or goods can be transported, for example. An AMR is an intelligent vehicle that can move autonomously and without external support in its environment.

The vehicle comprises a plurality of drive and steering devices and preferably a single control device, wherein the control device is configured to control the drive and steering devices jointly or separately. In particular, the control device is configured to control at least one, preferably both hollow shaft motors of the respective drive and steering device. Each drive and steering device can be controlled separately by the control device. The control device can also control a plurality of or all drive and steering devices together.

For this purpose, the control device can also communicate with sensors that record information about the environment, the operating state, the position of the vehicle or the like and provide it to the control device for evaluation, so that the vehicle, in particular the respective drive and steering device, can be controlled accordingly depending on this information.

The above statements, examples and definitions of technical effects, advantages and embodiments of the drive and steering device according to the invention according to the first aspect of the invention also apply mutatis mutandis to the vehicle according to the invention according to the second aspect of the invention, and vice versa.

Further measures to improve the invention are further described below together with a description of a preferred example of the invention using the figures, whereby identical or similar components are marked with the same reference sign. In the drawings:

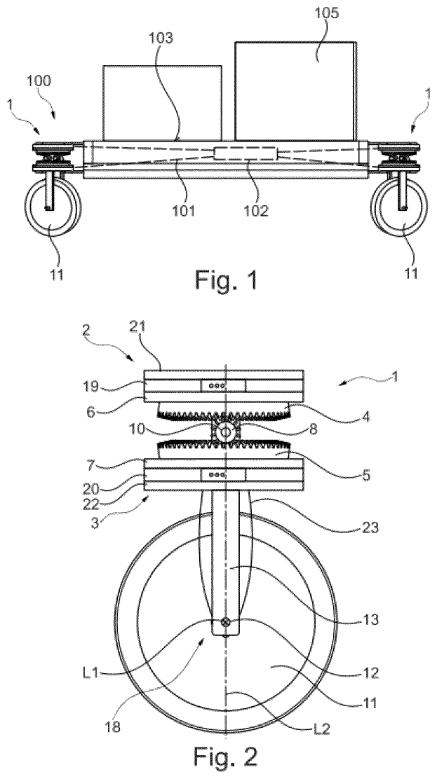

FIG. 1 shows a simplified schematic view of a vehicle according to the invention with four drive and steering devices according to the invention,

FIG. 2 shows a first schematic view of an exemplary drive and steering device according to FIG. 1,

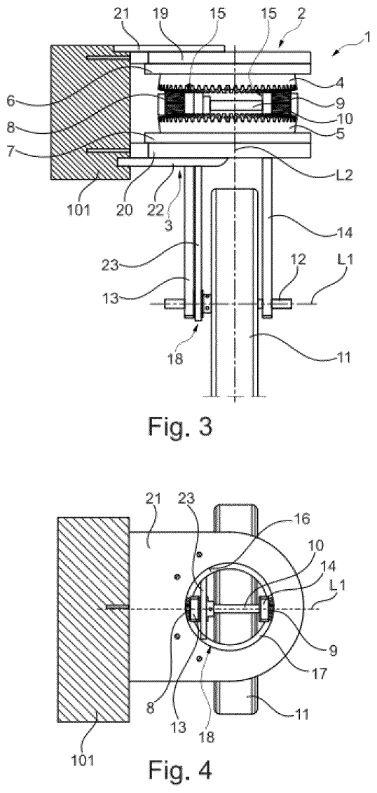

FIG. 3 shows a second schematic view of the drive and steering device according to the invention according to FIG. 1 and FIG. 2,

FIG. 4 shows a plan view of the drive and steering device according to the invention according to FIGS. 1 to 3,

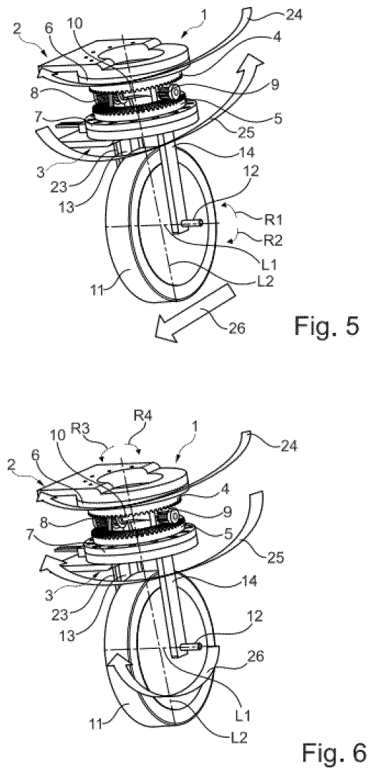

FIG. 5 shows a first perspective view of the drive and steering device according to the invention according to FIGS. 1 to 4 to illustrate a control of the drive and steering device during operation in a first driving situation, and

FIG. 6 shows a second perspective view of the drive and steering device according to the invention according to FIGS. 1 to 5 to illustrate a control of the drive and steering device during operation in a second driving situation.

FIG. 1 shows a vehicle 100 according to the invention in a highly simplified manner. The vehicle 100 comprises a chassis 101 with a platform 103, wherein four drive and steering devices 1 according to the invention are arranged and supported on the chassis 101, of which only two are shown here. A drive and steering device 1 is located at each corner of the chassis 101. The vehicle 100 is an AMR, wherein the drive and steering devices 1 are designed such that, in particular, a holonomic movement of the vehicle 100 is possible. The vehicle 100 comprises a control device 102 which is configured to communicate with the drive and steering devices 1 and to control them separately such that the vehicle 100 can be driven in the forward direction and in the reverse direction and a steering operation can take place. With such a vehicle 100, for example, goods 105 can be transported, which can be positioned on the platform 103.

FIGS. 2 to 6 show one of the drive and steering devices 1 of the vehicle 100 as an example, wherein the other three drive and steering devices 1 are designed identically. Therefore, all statements regarding the drive and steering device 1 described below apply equally to the three other drive and steering devices 1.

According to FIGS. 2 to 6, the drive and steering device 1 comprises a first hollow shaft motor 2, having a first bevel ring gear 4 that is indirectly rotationally fixed to a first rotor 6 of the first hollow shaft motor 2, and a first stator 19 which is fastened to and supported by a chassis 101 of the vehicle 100 via a first chassis mounting plate 21. Furthermore, the drive and steering device 1 comprises a second hollow shaft motor 3, having a second bevel ring gear 5 that is rotationally fixed to a second rotor 7 of the second hollow shaft motor 3, and a second stator 20 which is fastened to and supported by a chassis 101 of the vehicle 100 via a second chassis mounting plate 22. The connection of the chassis mounting plates 21, 22 to the chassis 101 is schematically indicated in FIG. 3 and FIG. 4.

The two bevel ring gears 4, 5 are arranged coaxially to one another and to the longitudinal axes of the stators 19, 20 and rotors 6, 7, wherein a first bevel pinion 8 and a second bevel pinion 9 are arranged spatially between the bevel ring gears 4, 5 and are connected to one another in a rotationally fixed manner via a shaft 10 arranged in between. Each of the bevel pinions 8, 9 is meshed with both the first bevel ring gear 4 and the second bevel ring gear 5 on diametrically opposite sides of the bevel ring gears 4, 5.

According to FIG. 3 and FIG. 4, two supporting arms 13, 14 are arranged on the shaft 10 via an associated rotary joint 15, wherein the rotary joints 15 allow the shaft 10 to rotate relative to the supporting arms 13, 14. The supporting arms 13, 14 rotatably receive a wheel hub 12 at one wheel-side end, wherein a wheel 11 is rotationally fixed on the wheel hub 12, so that a rotation of the wheel hub 12 about its longitudinal axis L1 causes a rotation of the wheel 11 about the longitudinal axis L1. The wheel 11 is arranged in the longitudinal direction of the wheel hub 12 along the longitudinal axis L1 between the two supporting arms 13, 14.

According to FIG. 4, the supporting arms 13, 14 are also radially supported on the second hollow shaft motor 3 via a bearing point 17 arranged on an inner circumference 16 of the second hollow shaft motor 3. The bearing point 17 is designed as an annular bearing bush and prevents the supporting arms 13, 14 from rotating about a longitudinal axis L2 of the drive and steering device 1. Thus, the rotors 6, 7 are arranged to rotate relative to the supporting arms 13, 14.

A mechanical force-transmission device 18 designed as a belt drive is effectively arranged between the shaft 10 and the wheel hub 12, which transmits a drive power introduced into the shaft 10, which causes the shaft 10 to rotate about its longitudinal axis, to the wheel hub 12 via a belt 23 in order to drive the wheel 11 in rotation. The pulleys on the shaft 10 or on the wheel hub 12, which hold the belt 23, are not shown in detail here for reasons of clarity.

The control device 102 shown in FIG. 1 is communicatively connected to the hollow shaft motors 2, 3, wherein by appropriate energization of the stators 19, 20 the rotors 6, 7 and thus the bevel ring gears 4, 5 can be driven in a rotational movement at a rotational speed about the longitudinal axis L2 of the drive and steering device 1. The bevel ring gears 4, 5 can be rotationally driven in the same rotational direction as well as in opposite rotational directions. Furthermore, the bevel ring gears 4, 5 can be driven at the same rotational speed or at different rotational speeds.

The bevel ring gears 4, 5 can be rotationally driven in particular such that, depending on the relative rotational direction and the relative rotational speed of the bevel ring gears 4, 5 to one another, a rotational driving of the wheel hub 12 about its longitudinal axis L1 and/or a pivoting of the wheel hub 12 about a longitudinal axis L2 of the drive and steering device 1 takes place in order to adjust a steering angle of the wheel 11. The adjustment of a steering angle of the wheel 11, i.e., the rotation of the wheel 11 about the second longitudinal axis L2, is based on the difference between the rotational speeds of the bevel ring gears 4, 5. The rotational driving of the wheel 11 about the first longitudinal axis L1 depends linearly on the respective rotational speed of the rotors 6, 7 or bevel ring gears 4, 5.

FIG. 5 shows a first case, according to which, when the bevel ring gears 4, 5 are rotated by the hollow shaft motors 2, 3 at the same rotational speed in opposite rotational directions, the wheel hub 12 rotates about its longitudinal axis L1 in the first rotational direction R1 or in a second rotational direction R2 opposite thereto. In the present case, the first bevel ring gear 4 rotates clockwise according to a first arrow 24 at a first speed and the second bevel ring gear 5 rotates counterclockwise according to a second arrow 25 at a second speed corresponding to the first speed. The bevel ring gears 4, 5 thus rotate at the same speed in opposite rotational directions. This causes the bevel pinions 8, 9 to rotate together at the same speed about the longitudinal axis of the shaft 10, so that the shaft 10 rotates about its longitudinal axis, whereby a drive power is transmitted to the wheel 11 via the force-transmission device 18 operatively connected to the shaft 10. Thus, the wheel 11 rotates in the first rotational direction R1. The mechanical force-transmission device 18 thus serves to transmit drive power from the shaft 10 to the wheel 11. In the case shown in FIG. 5, the wheel 11 is rotationally driven exclusively such that the drive and steering device 1 and thus the vehicle 100 moves along a third arrow 26, for example in the forward direction of travel of the vehicle 100. If, on the other hand, the first bevel ring gear 4 is rotated counterclockwise at a first speed and the second bevel ring gear 5 is rotated clockwise at an identical second speed, the third arrow 26 is directed in the opposite direction, which corresponds, for example, to a reverse direction of the vehicle 100 opposite to the forward direction of travel. Thus, the wheel 11 rotates in the second rotational direction R2 opposite to the first rotational direction R1. In this sense, the control device 102 is configured to control the hollow shaft motors 2, 3 such that the bevel ring gears 4, 5 are rotated at the same rotational speed in opposite rotational directions, whereby the wheel hub 12 rotates about its longitudinal axis L1 in a first rotational direction R1 or in a second rotational direction R2 opposite thereto.

FIG. 6 shows a second case, according to which, when the bevel ring gears 4, 5 are rotated by the hollow shaft motors 2, 3 at the same rotational speed in the same rotational direction, the wheel hub 12 is pivoted about the longitudinal axis L2 of the drive and steering device 1 in a third rotational direction R3 or in a fourth rotational direction R4 opposite thereto. Due to the relative rotational movement of the bevel ring gears 4, 5 according to FIG. 6, the shaft 10 rotates at its center point together with the bevel pinions 8, 9 about the longitudinal axis L2 of the drive and steering device 1, whereby the supporting arms 13, 14 arranged on the shaft 10 also rotate about the longitudinal axis L2 and thus pivot the wheel hub 12 and the wheel 11 about the longitudinal axis L2 to adjust a steering angle of the wheel 11. In the present case, the first bevel ring gear 4 rotates clockwise according to a first arrow 24 at a first speed and the second bevel ring gear 5 rotates clockwise according to a second arrow 25 at a second speed corresponding to the first speed. The bevel ring gears 4, 5 therefore rotate at the same speed in the same direction. In the case shown in FIG. 6, the wheel 11 is pivoted exclusively about the longitudinal axis L2 along a third arrow 26 to adjust a steering angle, for example to initiate a right-hand turn. Thus, the wheel 11, the wheel hub 12, the supporting arms 13, 14 and the shaft 10 rotate about the longitudinal axis L2 in the third rotational direction R2. If, on the other hand, both bevel ring gears 4, 5 are rotated together counterclockwise at an identical speed, the third arrow 26 is oriented in the opposite direction, for example to initiate a left turn of the vehicle 100. In this sense, the control device 102 is configured to control the hollow shaft motors 2, 3 such that the bevel ring gears 4, 5 are rotated at the same rotational speed in the same rotational direction, whereby the wheel hub 12 pivots about the longitudinal axis L2 of the drive and steering device 1 in a fourth rotational direction R4 opposite to the third rotational direction R3.

The two cases described in FIG. 5 and FIG. 6 can also be combined with each other in order to drive the respective wheel 11 during operation of the vehicle 100 and at the same time to initiate and execute cornering of the vehicle 100. In this sense, the control device 102 is configured to control the hollow shaft motors 2, 3 such that the bevel ring gears 4, 5 are rotated by the hollow shaft motors 2, 3 at different rotational speeds in opposite rotational directions, whereby the wheel hub 12 rotates about its longitudinal axis L1 in the first rotational direction R1 or in the second rotational direction R2 and pivots about the longitudinal axis L2 of the drive and steering device 1 in the third rotational direction R3 or the fourth rotational direction R4.

If, for example, the first bevel ring gear 4 is driven clockwise at a first speed and the second bevel ring gear 5 is driven counterclockwise at a second speed which is greater than the first speed, on the one hand a forward travel of the vehicle 100 can be realized analogously to the explanations for FIG. 5, while on the other hand at the same time the wheel 11 with the wheel hub 12, the shaft 10 and the supporting arms 13, 14 arranged thereon rotate counterclockwise about the longitudinal axis L2 of the drive and steering device 1 in order to set a steering angle of the wheel 11 in a first direction analogously to the explanations for FIG. 6.

If, in contrast, the first bevel ring gear 4 is driven clockwise at a first speed and the second bevel ring gear 5 is driven counterclockwise at a second speed which is lower than the first speed, a forward travel of the vehicle 100 (cf. FIG. 5) can also be realized, while at the same time the wheel 11 with the wheel hub 12, the shaft 10 and the supporting arms 13, 14 arranged thereon rotate clockwise about the longitudinal axis L2 of the drive and steering device 1 in order to set a steering angle of the wheel 11 in a second direction opposite to the first direction (cf. FIG. 6).

If, in a further driving state in which the vehicle 100 is to be driven backwards, the first bevel ring gear 4 is driven counterclockwise at a first speed and the second bevel ring gear 5 is driven clockwise at a second speed which is greater than the first speed, the vehicle 100 can be driven backwards, while at the same time the wheel 11 with the wheel hub 12, the shaft 10 and the supporting arms 13, 14 arranged thereon rotate counterclockwise about the longitudinal axis L2 of the drive and steering device 1 in order to set a steering angle of the wheel 11 in the first direction.

If, in contrast, the first bevel ring gear 4 is driven counterclockwise at a first speed and the second bevel ring gear 5 is driven clockwise at a second speed which is lower than the first speed, the vehicle 100 can also be driven backwards, while at the same time the wheel 11 with the wheel hub 12, the shaft 10 and the supporting arms 13, 14 arranged thereon rotate clockwise about the longitudinal axis L2 of the drive and steering device 1 in order to set a steering angle of the wheel 11 in a second direction opposite to the first direction.

Due to the coaxial arrangement of all components along the longitudinal axis L2 of the drive and steering device 1, a space-saving drive and steering device 1 can be realized, which enables a comparatively large ground clearance under the chassis 101. In addition, such a drive and steering device 1 enables the wheel 11 to be rotated by 360°, whereby the vehicle 100 can be used in a variety of different applications.

It is understood that the invention is not limited to the embodiment described here with the various alternatives. For example, further components can be effectively arranged between the rotors 6, 7 and the associated bevel ring gears 4, 5 in order, for example, to facilitate or simplify the connection of the hollow shaft motors 2, 3 to the chassis 101. Alternatively or additionally, only a single supporting arm 13 or 14 may be provided, on which the wheel 11 with the wheel hub 12 is arranged. This can be advantageous if the loads to be carried by the vehicle 100 are comparatively small.

### List of Reference Signs

1 Drive and steering device
2 First hollow shaft motor
3 Second hollow shaft motor
4 First bevel ring gear
5 Second bevel ring gear
6 First rotor
7 Second rotor
8 First bevel pinion
9 Second bevel pinion
10 Shaft
11 Wheel
12 Wheel hub
13 First supporting arm
14 Second supporting arm
15 Rotary joint
16 Inner circumference of the second hollow shaft motor
17 Bearing point on the second hollow shaft motor
18 Mechanical force-transmission device
19 First stator
20 Second stator
21 First chassis mounting plate
22 Second chassis mounting plate
23 Belt
24 First arrow
25 Second arrow
26 Third arrow
100 Vehicle
101 Chassis
102 Control device
103 Platform
104 Goods
L1 Longitudinal axis of the wheel hub
L2 Longitudinal axis of the drive and steering device
R1 First rotational direction
R2 Second rotational direction
R3 Third rotational direction
R4 Fourth rotational direction

1. A drive and steering device for a vehicle, comprising:
a first hollow shaft motor, having a first rotor and a first bevel ring gear that is at least indirectly rotationally fixed to the first rotor,
a second hollow shaft motor, having a second rotor and a second bevel ring gear that is at least indirectly rotationally fixed to the second rotor, wherein the first and second bevel ring gears are arranged coaxially to one another,
a first bevel pinion and a second bevel pinion, wherein the first and second bevel pinions are rotationally fixed to one another via a shaft arranged in between, and wherein each of the first and second bevel pinions is meshed with both the first bevel ring gear and the second bevel ring gear,
a wheel of the vehicle arranged on a wheel hub in a rotationally fixed manner,
at least one supporting arm on which the wheel hub is rotatably arranged, wherein the at least one supporting arm is arranged on the shaft via at least one rotary joint and is radially supported on the second hollow shaft motor via a bearing point arranged on an inner circumference of the second hollow shaft motor,
a mechanical force-transmission device that is drivingly arranged between the shaft and the wheel hub for rotationally driving the wheel hub about a longitudinal axis thereof, wherein the first and second bevel ring gears are rotationally driven by first and second hollow shaft motors, respectively, in such a way that, according to a relative rotational direction and relative rotational speed of the first and second bevel ring gears to one another, there is at least one of a rotational driving of the wheel hub about the longitudinal axis or a pivoting of the wheel hub about a longitudinal axis of a drive and steering device in order to adjust a steering angle of the wheel of the vehicle.

2. The drive and steering device according to claim 1, wherein the at least one supporting arm comprises two supporting arms, the wheel hub is rotatably arranged on the two supporting arms, and the wheel of the vehicle is arranged in the longitudinal direction of the wheel hub between the two supporting arms.

3. The drive and steering device according to claim 1, wherein
the mechanical force-transmission device is a traction drive or a gear transmission.

4. The drive and steering device according to claim 1, wherein a first stator of the first hollow shaft motor is configured to be fastened to a chassis of the vehicle via a first chassis mounting plate.

5. The drive and steering device according to claim 1, wherein a second stator of the second hollow shaft motor is configured to be fastened to a chassis of the vehicle via a second chassis mounting plate.

6. The drive and steering device according to claim 1, wherein a controller which is configured to control the first sand second hollow shaft motors in such a way that the first and second bevel ring gears are rotated at the same rotational speed in opposite rotational directions, whereby the wheel hub rotates about the longitudinal axis thereof in a first rotational direction or in a second rotational direction opposite thereto.

7. The drive and steering device according to claim 1, wherein a controller is configured to control the first and second hollow shaft motors such that the first and second bevel ring gears are rotated at the same rotational speed in the same rotational direction, whereby the wheel hub pivots about the longitudinal axis of the drive and steering device in a third rotational direction or in a fourth rotational direction opposite thereto.

8. The drive and steering device according to claim 1, wherein a control device is configured to control the first and second hollow shaft motors in such a way that the first and second bevel ring gears are rotated by the first and second hollow shaft motors at different rotational speeds in opposite rotational directions, whereby the wheel hub rotates about the longitudinal axis thereof in a first rotational direction or in a second rotational direction and pivots about the longitudinal axis of the drive and steering device in a third rotational direction or a fourth rotational direction.

9. A vehicle comprising at least one of the drive and steering device according to claim 1, wherein the at least one drive and steering device is arranged and supported on a chassis of the vehicle.

10. The vehicle according to claim 9, wherein the at least one of the drive and steering device comprises a plurality of drive and steering devices and a controller, wherein the controller is configured to control the plurality of the drive and steering devices separately.
